(19) United States
(12) Patent Application Publication
(10) Pub. No.: US 2018/0173248 A1
(43) Pub. Date: Jun. 21, 2018

(54) APPARATUS AND METHOD FOR A WATER CONSERVATION SYSTEM

(71) Applicant: Ark Innovations, Inc., Florence, AL (US)

(72) Inventors: Robbie Hillis, Florence, AL (US); Rodney Robbins, Florence, AL (US); Jerry Robbins, Alabaster, AL (US)

(73) Assignee: Ark Innovations, Inc., Florence, AL (US)

(21) Appl. No.: 15/735,432

(22) PCT Filed: Jun. 16, 2016
(86) PCT No.: PCT/US2016/037828

§ 371 Date: Dec. 11, 2017

Related U.S. Application Data
(60) Provisional application No. 62/180,439, filed on Jun. 16, 2015.

(51) Int. Cl. G05D 7/06; G05D 16/20; E03D 5/10; E03B 7/07

(52) U.S. Cl. CPC G05D 7/06; E03B 7/071; E03D 5/105; G05D 16/20

(57) ABSTRACT

A water conservation system adapted to control the flow of water to a structure comprising a valve assembly having an inlet adapted to receive a water flow, an outlet adapted to allow the water flow to exit the valve assembly, a flow detector adapted to measure the water flow through the valve assembly, a shutoff valve adapted to stop the water flow through the valve assembly, a power source adapted to provide power to the valve assembly, a circuit board that includes at least one microchip, and a microprocessor that is adapted to operatively communicate with the valve assembly. A method for conserving water comprising providing a water conservation system and controlling the flow of water to the structure.

### CROSS-REFERENCES TO RELATED APPLICATIONS/PATENTS

This application relates back to and claims the benefit of priority from U.S. Provisional Application for Patent Ser. No. 62/180,439 titled “Smart Valve” and filed on Jun. 16, 2015.

### FIELD OF THE INVENTION

The present invention relates generally to systems and methods for water conservation, and particularly to systems and methods for valve assemblies adapted to conserve water.

### BACKGROUND AND DESCRIPTION OF THE PRIOR ART

It is known to use systems and methods to conserve water. Conventional systems and methods, however, suffer from one or more disadvantages. For example, conventional water conservation systems and methods are adapted to detect only major failures such as a broken pipe or a significant leak. Conventional water conservation systems and methods are adapted to monitor residential homes or commercial buildings as a whole and not on a fixture-by-fixture basis. Conventional water conservation systems and methods do not learn the water usage and habits of home or building. In addition, conventional water conservation systems and methods do not notify a residential homeowner or commercial building owner in the event an abnormality is detected at a home or building. Conventional water conservation systems and methods also do not automatically shut off the water flow to a home or building in the event an abnormality is detected. Conventional water conservation systems and methods are also undesirably inefficient.

It would be desirable, therefore, if an apparatus and method for a water conservation system could be provided that would detect relatively minor leaks. It would also be desirable if such an apparatus and method for a water conservation system could be provided that would monitor residential homes and commercial buildings on a fixture-by-fixture basis. It would be further desirable if such an apparatus and method for a water conservation system could be provided that would learn the water usage and habits of a home or building. It would be still further desirable if such an apparatus and method for a water conservation system could be provided that would automatically notify a homeowner or commercial building owner in the event an abnormality is detected at a home or building. It would also be desirable if such an apparatus and method for a water conservation system could be provided that would automatically shut off the water flow to a home or building in the event an abnormality is detected. In addition, it would also be desirable if such an apparatus and method for a water conservation system could be provided that would efficiently conserve water.

### Advantages of the Preferred Embodiments of the Invention

Accordingly, it is an advantage of the preferred embodiments of the invention claimed herein to provide an apparatus and method for a water conservation system that detects relatively minor leaks. It is also an advantage of the preferred embodiments of the invention claimed herein to provide an apparatus and method for a water conservation system that monitors residential homes and commercial buildings on a fixture-by-fixture basis. It is a further advantage of the preferred embodiments of the invention claimed herein to provide an apparatus and method for a water conservation system that learns the water usage and habits of a home or a building. It is a still further advantage of the preferred embodiments of the invention claimed herein to provide an apparatus and method for a water conservation system that automatically notifies a homeowner or commercial building owner in the event an abnormality is detected at a home or a building. It is also an advantage of the preferred embodiments of the invention claimed herein to provide an apparatus and method for a water conservation system that automatically shuts off the water flow to a home or building in the event an abnormality is detected. In addition, it is an advantage of the preferred embodiments of the invention claimed herein to provide an apparatus and method for a water conservation system that efficiently conserves water.

### SUMMARY OF THE INVENTION

The apparatus of the invention comprises a water conservation system adapted to control the flow of water to a structure. The preferred water conservation system comprises a valve assembly having an inlet that adapted to receive a water flow, an outlet that is adapted to allow the water flow to exit the valve assembly, a flow detector that is adapted to measure the water flow through the valve assembly, a shutoff valve that is adapted to stop the water flow through the valve assembly, a power source that is adapted to provide power to the valve assembly, a circuit board that includes at least one microchip, and a microprocessor that is adapted to operatively communicate with the valve assembly.

The method of the invention comprises a method for conserving water. The preferred method comprises providing a water conservation system. The preferred water conservation system comprises a valve assembly having an inlet that is adapted to receive a water flow, an outlet that is adapted to allow the water flow to exit the valve assembly, a flow detector that is adapted to measure the water flow through the valve assembly, a shutoff valve that is adapted to stop the water flow through the valve assembly, a power source that is adapted to provide power to the valve assembly, a circuit board that includes at least one microchip, and a microprocessor that is adapted to operatively communicate with the valve assembly. The preferred method for conserving water also comprises controlling the flow of water to the structure.

### BRIEF DESCRIPTION OF THE DRAWINGS

The presently preferred embodiments of the invention are illustrated in the accompanying drawings, in which like reference numerals represent like parts throughout, and in which:

FIG. 1 is a partial sectional front view of the preferred embodiment of the preferred valve assembly in accordance with the present invention.

FIG. 2 is a front view of the preferred valve assembly illustrated in FIG. 1.

FIG. 3 is a right end view of the preferred valve assembly illustrated in FIGS. 1-2.

FIG. 4 is a left end view of the preferred valve assembly illustrated in FIGS. 1-3.

FIG. 5 is a top view of the preferred valve assembly illustrated in FIGS. 1-4.

FIG. 6 is a bottom view of the preferred valve assembly illustrated in FIGS. 1-5.

FIG. 7 is a flow chart illustrating the preferred algorithm performed by the water conservation system when it is operating in the manual mode.

FIG. 8 is a flow chart illustrating the preferred algorithm performed by the water conservation system when it is operating in the learn mode.

FIG. 9 is a flow chart illustrating the preferred algorithm performed by the water conservation system when it detects an abnormal water flow.

FIG. 10 is a schematic illustrating the preferred software architecture of the water conservation system in accordance with the present invention.

### DESCRIPTION OF THE PREFERRED EMBODIMENTS OF THE INVENTION

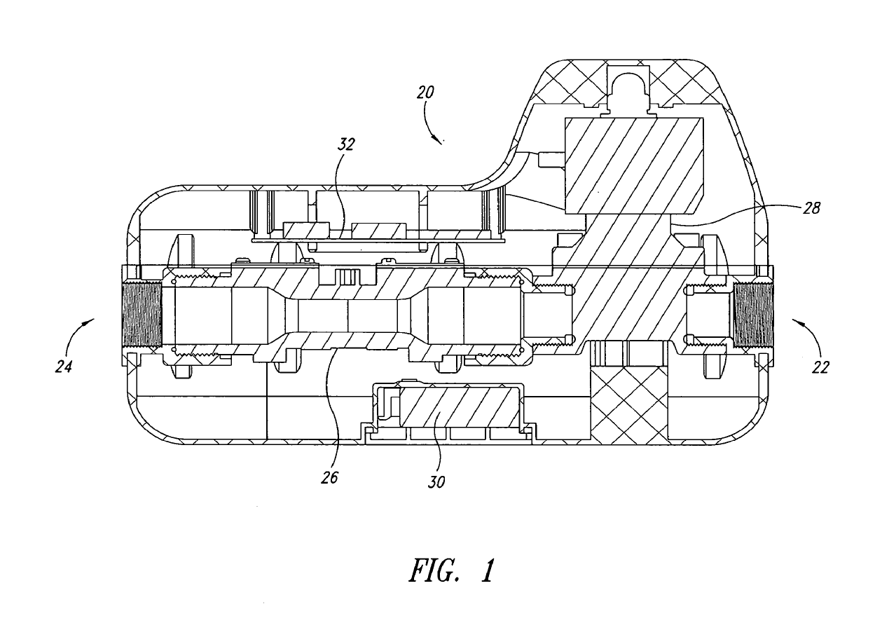

Referring now to the drawings, the preferred embodiments of the apparatus and method for a water conservation system in accordance with the present invention are illustrated by FIGS. 1 through 10. As shown in FIGS. 1-10, the preferred embodiments of the water conservation systems are adapted to detect relatively minor leaks. The preferred embodiments of the water conservation system are also adapted to monitor residential homes and commercial buildings on a fixture-by-fixture basis. The preferred embodiments of the water conservation system are further adapted to learn the water usage and habits of a home or building. The preferred embodiments of the water conservation system are still further adapted to automatically notify a homeowner or commercial building owner in the event an abnormality is detected at a home or building. The preferred embodiments of the water conservation system are also adapted to automatically shut off the water flow to a home or building in the event an abnormality is detected. In addition, the preferred embodiments of the water conservation system are adapted to efficiently conserve water.

Referring now to FIG. 1, a partial sectional front view of the preferred valve assembly in accordance with the present invention is illustrated. As shown in FIG. 1, the preferred valve assembly is designated generally by reference numeral 20. Preferred valve assembly 20 comprises inlet 22 which is adapted to receive a water flow, outlet 24 which is adapted to allow the water flow to exit the valve assembly, flow detector 26 which is adapted to measure the water flow through the valve assembly, shutoff valve 28 which is adapted to stop the water flow through the valve assembly, power source 30 which is adapted to provide power to the valve assembly, and circuit board 32 which as at least one microchip. Preferred flow detector 26 comprises s sonic flow detector, preferred shutoff valve 28 comprises a solenoid valve, preferred power source 30 comprises a battery, and preferred circuit board 32 comprises at least one integrated circuit. In the preferred embodiments of the water conservation system, valve assembly 20 automatically shuts off the water flow to a structure such as a residential home or commercial building in the event an abnormal usage is detected. While FIG. 1 illustrates the preferred configuration and arrangement of the valve assembly in accordance with the present invention, it is contemplated within the scope of the invention that the valve assembly may be of any suitable configuration and arrangement. It is also contemplated within the scope of the invention that the power source may comprise a renewable energy source or an electrical energy source.

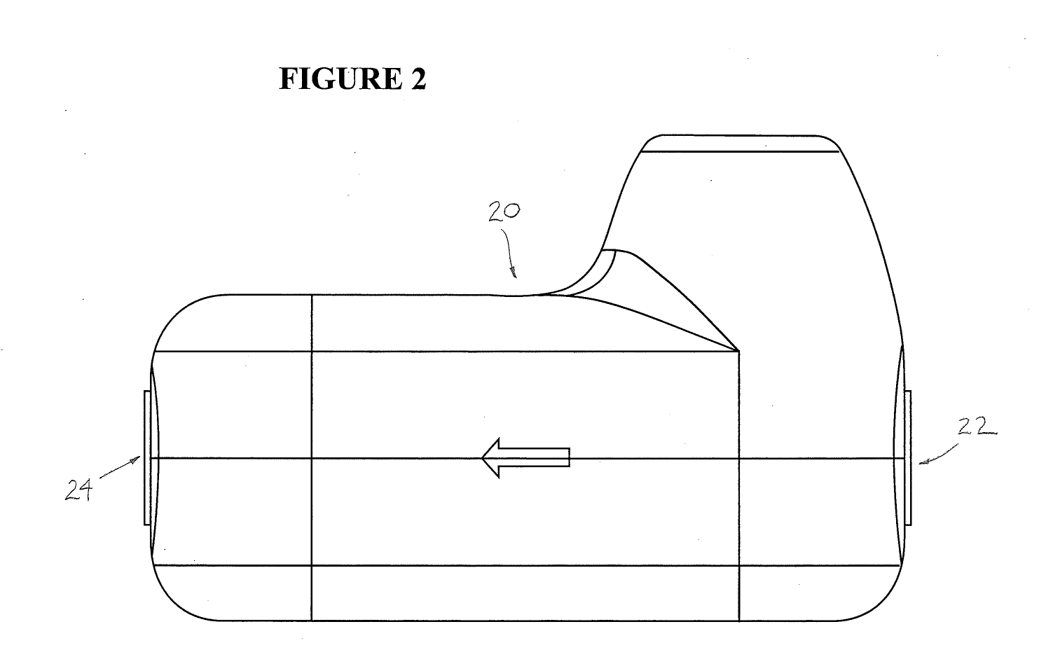

Referring now to FIG. 2, a front view of preferred valve assembly 20 is illustrated. As shown in FIG. 2, preferred valve assembly 20 comprises inlet 22 and outlet 24.

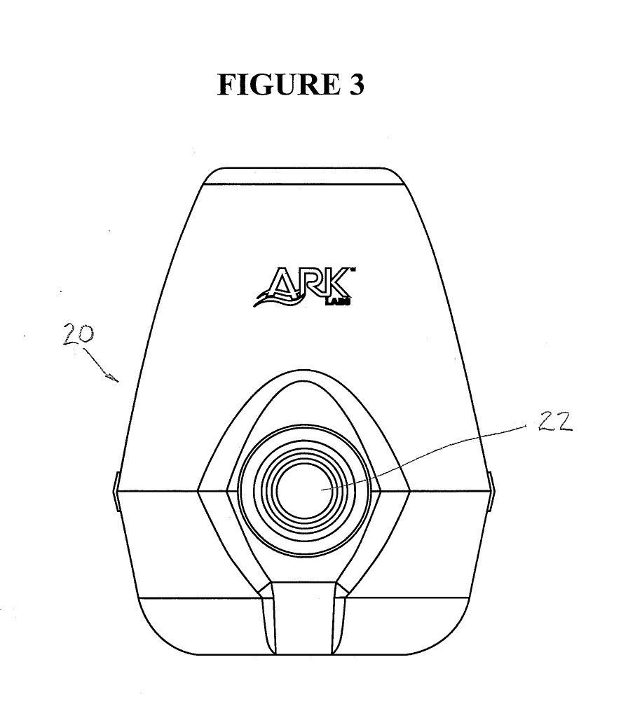

Referring now to FIG. 3, a right end view of preferred valve assembly 20 is illustrated. As shown in FIG. 3, preferred valve assembly 20 comprises inlet 22.

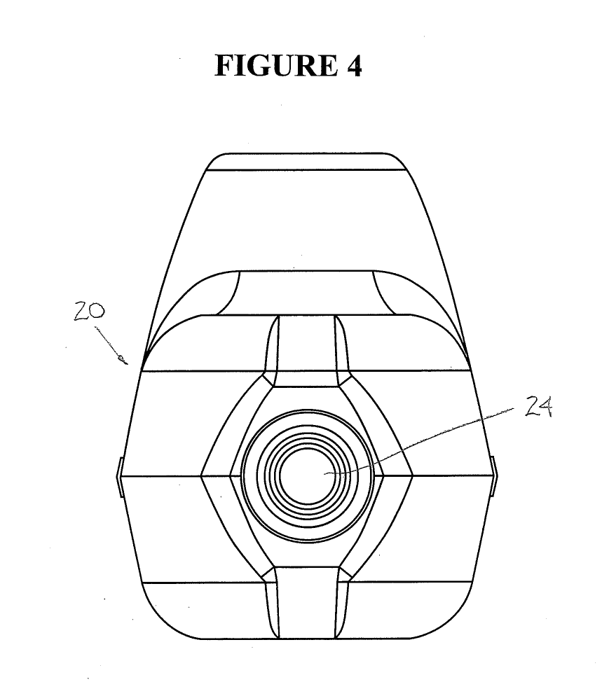

Referring now to FIG. 4, a left end view of preferred valve assembly 20 is illustrated. As shown in FIG. 4, preferred valve assembly 20 comprises outlet 24.

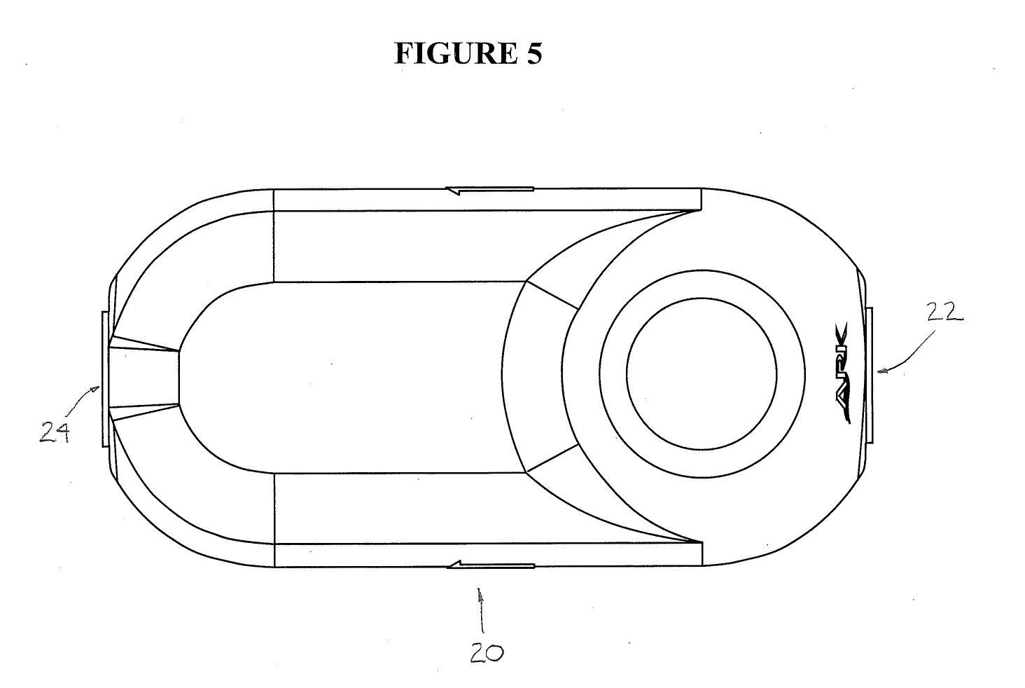

Referring now to FIG. 5, a top view of preferred valve assembly 20 is illustrated. As shown in FIG. 5, preferred valve assembly 20 comprises inlet 22 and outlet 24.

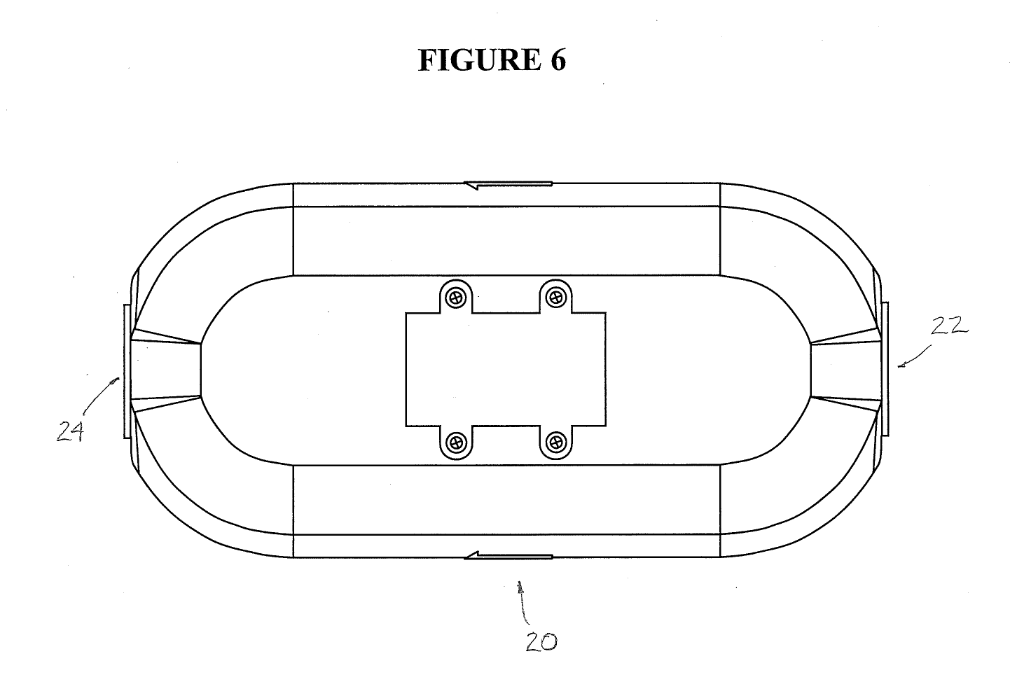

Referring now to FIG. 6, a top view of preferred valve assembly 20 is illustrated. As shown in FIG. 6, preferred valve assembly 20 comprises inlet 22 and outlet 24.

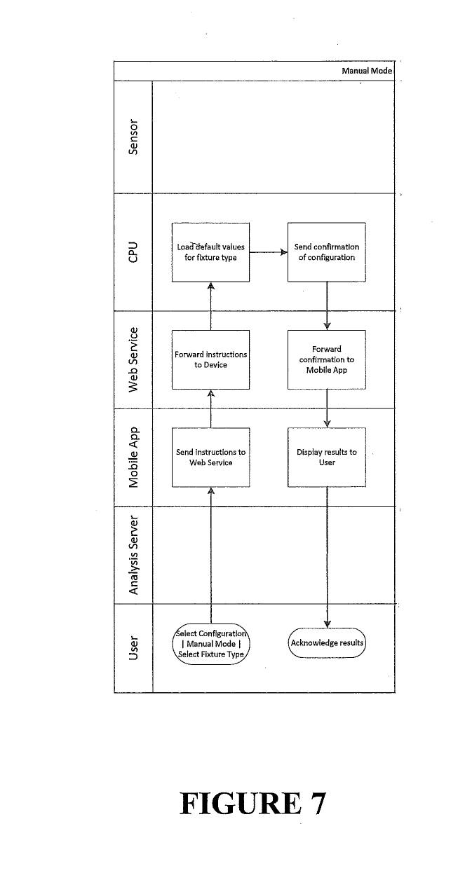

Referring now to FIG. 7, a flow chart illustrating the preferred algorithm performed by the water conservation system when it is operating in the manual mode. As shown in FIG. 7, the preferred algorithm begins with the user selecting the manual mode configuration and selecting a fixture type, e.g. faucet, toilet, etc., via a mobile application. The user's selections are conveyed to a microprocessor or CPU via Web services such as the Internet. The microprocessor then sends a confirmation of the user's selections to the user's mobile application via Web services. The user then may acknowledge the selections displayed on the mobile application.

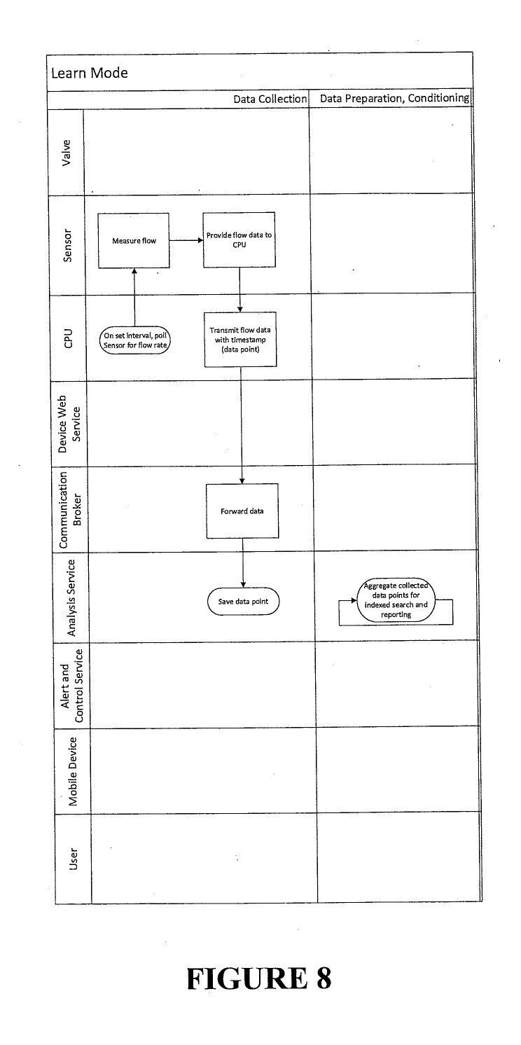

Referring to FIG. 8, a flow chart illustrating the preferred algorithm performed by the water conservation system when it is operating in the learn mode. As shown in FIG. 8, the preferred algorithm begins with the microprocessor collecting water flow data from a sensor such as a flow rate detector on a pre-set interval. The microprocessor conveys the water flow data with a timestamp or data point to a communication broker which conveys the data to an analysis server. The analysis server saves the water flow data point and aggregates the collected data points for an indexed search and reporting.

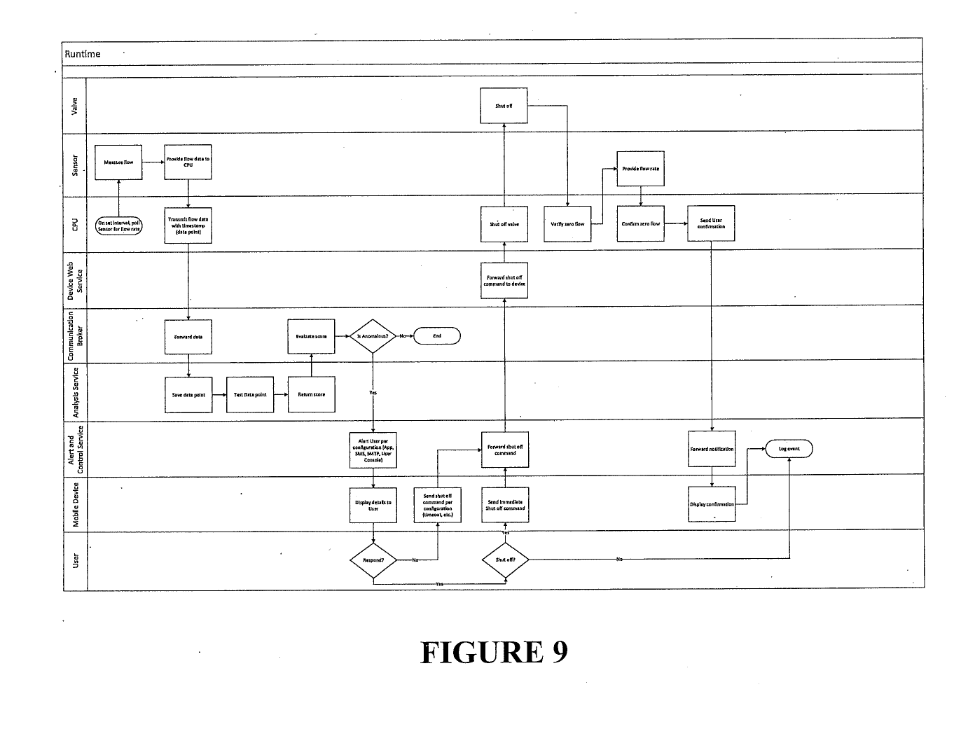

Referring now to FIG. 9, a flow chart illustrating the preferred algorithm performed by the water conservation system when it detects an abnormal water flow. As shown in FIG. 9, the microprocessor or CPU polls the sensor for the flow rate on a pre-set interval, the sensor measures the water flow rate through the valve assembly and conveys this data to the microprocessor or CPU. The microprocessor then transmits the time-stamped flow data to the communication broker which conveys the data to the analysis server. The analysis server then saves the data, tests the data, and returns a score. The score is conveyed to the communication broker which evaluates the score. If the score is not anomalous or abnormal, then the process ends. If, on the other hand, the score is anomalous or abnormal, the communication broker conveys an alert to the alert and control service and the alert is passed along to the user's mobile device. If the user does not respond after a pre-determined amount of time, the mobile application sends a shut off command to the microprocessor via the alert and control service and the Web services and the microprocessor causes the valve to be shut, and verifies a zero flow rate at the valve via the sensor. After the microprocessor confirms the zero flow rate at the valve via the sensor, the microprocessor sends a confirmation to the user's mobile device via the alert and control service, and the event is logged. If, on the other hand, the user responds to the notification of an abnormal water flow, the user can elect to leave the valve open and the event will be logged via the alert and control service. Alternatively, the user can elect to shut off the valve and the process will follow the same steps as the system performs in the event the user does not respond to a notification within the pre-determined amount of time.

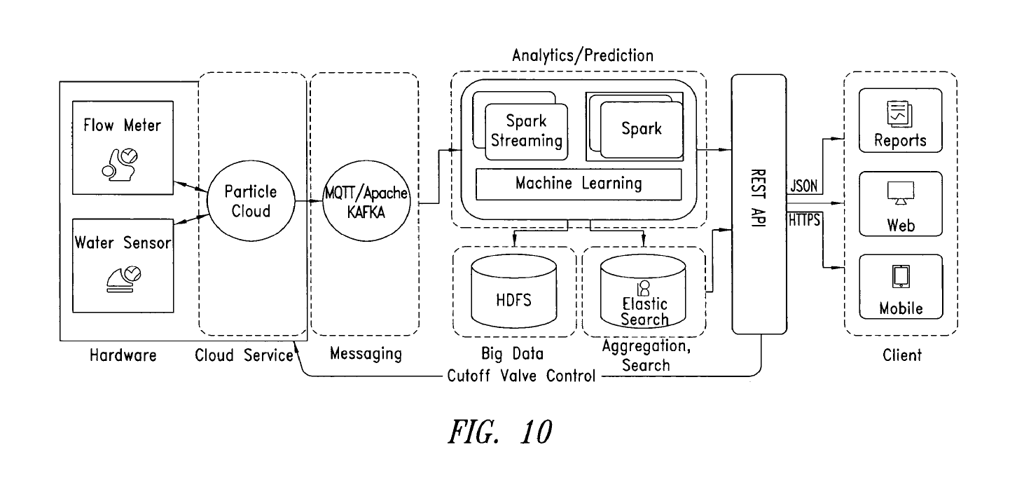

Referring now to FIG. 10, a schematic illustrating the preferred software architecture of the water conservation system is illustrated. As shown in FIG. 10, the preferred software architecture is adapted to control two items of hardware, i.e. a flow meter and water sensor. The preferred system uses cloud services and messaging software to facilitate communications between the hardware and user. The preferred system also uses machine learning software, aggregation and search software, and big data software for the purpose of processing and analyzing data and producing predictions based on the data. The preferred system also uses application processing interfaces to produce reports and provide communications to the user.

The invention also comprises a method for conserving water. The preferred method comprises providing a water conservation system adapted to control the flow of water to a structure such as a residential home or a commercial building. The preferred water conservation system comprises a valve assembly having an inlet that is adapted to receive a water flow, an outlet that is adapted to allow the water flow to exit the valve assembly, a flow detector that is adapted to measure the water flow through the valve assembly, a shutoff valve that is adapted to stop the water flow through the valve assembly, a power source that is adapted to provide power to the valve assembly, a circuit board that includes at least one microchip, and a microprocessor that is adapted to operatively communicate with the valve assembly. The preferred method for conserving water also comprises controlling the flow of water to the structure.

In other preferred embodiments of the method for conserving water, the microprocessor comprises software adapted to learn a normal water usage of the structure using probabilistic logic. Also in other preferred embodiments of the method, the microprocessor is adapted to convey a message to a user in the event an abnormal water usage is detected and the valve assembly automatically shuts off the water flow to the structure in the event an abnormal usage is detected. The preferred water conservation system is adapted to detect water leaks in the range of approximately one-eighth (⅛) of a gallon per minute to approximately one-thirty-second ( 1/32) of a gallon per minute.

In operation, several advantages of the preferred embodiments of the apparatus and method for a water conservation system are achieved. For example, the preferred embodiments of the water conservation system use machine learning to determine if the water flow in a house or a building at a given moment is anomalous or abnormal. The machine learning system leverages analytical models such as cluster and time series analysis to support real time pattern recognition. This probabilistic approach is superior to detection models which rely on pre-defined rules. More particularly, deterministic models compare current behavior with a set of pre-defined rules. The rule set, no matter how large, is limited to conditions generated at the time of construction, or as of the latest update, of the system. By contrast, the probabilistic approach compares current behavior with patterns observed and recorded over time. This allows the system to learn what is ‘normal’ for the environment, e.g. the house or the building, in which the system is used, and, over time, to continuously improve that definition based on real world data collected by the system. This leads to superior results, e.g. more accurate detections and fewer false alarms, over time. In addition, the preferred system is also adapted perform predictions.

In addition, the preferred printed circuit board (PCB) uses an integrated circuit (IC) chip from that translates the data from the flow tube sensor, then it relays to another IC chip which communicates the data to the cloud. The valve assembly is powered by a 9V battery so the power must be stepped down to 5V in order to operate with the preferred IC chip. Then the power is stepped back up through a DC converter to power the valve assembly if the second IC chip sends it a signal to turn off the valve or to open it up. The second IC chip is adapted to send a positive signal to one pole on the shutoff valve to close it and send a positive signal to the opposite pole on the shutoff valve to open it. The preferred shutoff valve is a latching mechanism valve that requires only a brief burst of power to operate and then a brief burst of power to reverse it. The preferred shutoff valve does not require continuous power to cause it to remain in either the open or closed position.

Still further, the preferred embodiments of the water conservation system are adapted to send a message to a user in the event of an anomalous or abnormal water flow event. The preferred system uses a light-weight messaging protocol, such as MQTT, which is specifically designed for machine-to-machine communication using a publish-subscribe messaging pattern or mechanism. The preferred system also uses an open-source message broker which is specifically designed for server-to-server communications. More particularly, the message broker provides a unified, high-throughput, low-latency platform for handling real-time data feeds that is a massively scalable publish-subscribe message queue that is designed as a distributed transaction log. By using a dedicated messaging broker, the system is capable of decoupling, scheduling, and delivering messages without any risk of error.

The preferred embodiments of the water conservation system also processes data using an open-source cluster computing framework that provides an interface for programming entire clusters with implicit data parallelism and fault-tolerance. The preferred application programming interface is centered on a resilient distributed dataset (RDD) which is a read-only multi-set of data items over a cluster of machines that is maintained in a fault-tolerant way. The RDD facilitates the implementation of both iterative algorithms that visit their dataset multiple times in a loop and interactive or exploratory data analysis which involves the repeated database-style querying of data. The system's preferred machine learning system is an iterative algorithm. The preferred data processor also uses a cluster manager and a distributed storage system. Preferably, the data processor is capable of performing scalable, fault-tolerant streaming analytics in which it ingests mini-batches of data and performs RDD transformations of the mini-batches of data. In addition, the preferred data processor is adapted to use the same application code written for batch analytics and for streaming analytics on a single engine. The preferred data processor is also adapted to perform distributed storage and distributed processing of very large data sets. In addition, the preferred system comprises an events and notification module that monitors the data processor for anomalies or abnormalities and is adapted to trigger notifications such as emails, push notifications, and SMSs. The preferred system also comprises a search server that provides a high indexing, distributed, scalable, multitenant capable full-text search engine with an HTTP interface. Preferably, the search server is capable of near real-time searching, and rebalancing and routing are performed automatically. The preferred search server also has a powerful aggregation framework for facilitating reporting.

The preferred water conservation system also exposes the data it collects and processes as secure representational state transfer (REST) application programming interface (API) which allows a plurality of users to access the data via a plurality of different means such of mobile devices or the Internet. More particularly, mobile applications such as iOS and Android may be used to register and connect the user's mobile device to a Wi-Fi network so that the user can access real-time data collected by the system or receive notifications from the system. Alternatively, a web-based application can be accessed by users to access real-time data collected by the system or receive notifications from the system. In addition, the web-based application includes an administration module which allows an administrator to access reports, update fill aware, and the like.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A water conservation system adapted to control the flow of water to a structure, said water conservation system comprising:
(a) a valve assembly, said valve assembly comprising:
(1) an inlet, said inlet being adapted to receive a water flow;
(2) an outlet, said outlet being adapted to allow the water flow to exit the valve assembly;
(3) a flow detector, said flow detector being adapted to measure the water flow through the valve assembly;
(4) a shutoff valve, said shutoff valve being adapted to stop the water flow through the valve assembly;
(5) a power source, said power source being adapted to provide power to the valve assembly;
(6) a circuit board, said circuit board having at least one microchip;
(b) a microprocessor, said microprocessor being adapted to operatively communicate with the valve assembly.

2. The water conservation system of claim 1 wherein the flow detector comprises a sonic flow detector.

3. The water conservation system of claim 1 wherein the shutoff valve comprises a solenoid valve.

4. The water conservation system of claim 1 wherein the power source comprises a battery.

5. The water conservation system of claim 1 wherein the power source comprises a renewable energy power source.

6. The water conservation system of claim 1 wherein the power source comprises an electrical energy power source.

7. The water conservation system of claim 1 wherein the circuit board comprises at least one integrated circuit.

8. The water conservation system of claim 1 wherein the microprocessor comprises software adapted to learn a normal water usage of the structure.

9. The water conservation system of claim 6 wherein the microprocessor software learns the normal water usage of the structure using probabilistic logic.

10. The water conservation system of claim 6 wherein the microprocessor is adapted to convey a message to a user in the event an abnormal water usage is detected.

11. The water conservation system of claim 6 wherein the valve assembly automatically shuts off the water flow to the structure in the event an abnormal usage is detected.

12. The water conservation system of claim 1 wherein the system is adapted to detect water leaks in the range of approximately one-eighth (⅛) of a gallon per minute to approximately one-thirty-second ( 1/32) of a gallon per minute.

13. The water conservation system of claim 1 further comprises an analysis server.

14. A method for conserving water, said method comprising:
(a) providing a water conservation system adapted to control the flow of water to a structure, said water conservation system comprising:
(1) a valve assembly, said valve assembly comprising:
(i) an inlet, said inlet being adapted to receive a water flow;
(ii) an outlet, said outlet being adapted to allow the water flow to exit the valve assembly;
(iii) a flow detector, said flow detector being adapted to measure the water flow through the valve assembly;
(iv) a shutoff valve, said shutoff valve being adapted to stop the water flow through the valve assembly;
(v) a power source, said power source being adapted to provide power to the valve assembly;
(vi) a circuit board, said circuit board having at least one microchip;
(2) a microprocessor, said microprocessor being adapted to operatively communicate with the valve assembly;
(b) controlling the flow of water to the structure.

15. The method of claim 14 wherein the microprocessor comprises software adapted to learn a normal water usage of the structure.

16. The method of claim 15 wherein the microprocessor software learns the normal water usage of the structure using probabilistic logic.

17. The method of claim 15 wherein the microprocessor is adapted to convey a message to a user in the event an abnormal water usage is detected.

18. The method of claim 15 wherein the valve assembly automatically shuts off the water flow to the structure in the event an abnormal usage is detected.

19. The method of claim 14 wherein the power source comprises a battery.

20. The method of claim 14 wherein the power source comprises a renewable energy power source.
